(19) United States
(12) Patent Application Publication
(10) Pub. No.: US 2015/0350714 A1
(43) Pub. Date: Dec. 3, 2015

(54) PLAYBACK OF VIDEO ON DEMAND

(71) Applicant: Apple Inc., Cupertino, CA (US)

(72) Inventors: James O. Normile, Los Altos, CA (US); Hsi-Jung Wu, San Jose, CA (US); Xiaosong Zhou, Campbell, CA (US); Chris Y. Chung, Sunnyvale, CA (US); Ke Zhang, San Jose, CA (US); Yeping Su, Sunnyvale, CA (US)

(73) Assignee: Apple Inc., Cupertino, CA (US)

(21) Appl. No.: 14/290,227

(22) Filed: May 29, 2014

(51) Int. Cl. H04N 21/433; H04N 21/258; H04N 21/437; H04N 21/81

(52) U.S. Cl. CPC H04N 21/433; H04N 21/812; H04N 21/25891; H04N 21/437

(57) ABSTRACT

A method and system for caching and streaming media content, including predictively delivering and/or acquiring content is provided. In the system, client devices may be communicatively coupled in a network, and may access and share cached content. Video segments making up a media stream may be selectively delivered to the clients such that a complete media stream may be formed from the different segments delivered to the different clients. Video segments may be pushed by the server to the client or requested by the client according to a prioritization scheme, including downloading: partial items on a client's subscription log, lower quality version(s) of content before higher quality version(s), higher bitrate segments before lower bitrate segments, summaries of full-length content, advertisements and splash screens common to multiple video clips.

### BACKGROUND

The present disclosure relates to caching and streaming of video content and, in particular, to techniques for predictively delivering and/or acquiring content for instantaneous viewing.

Currently, network-based media delivery services are available that support delivery of coded video. Those media delivery services typically code an input video sequence (“media stream”) as coded video data that has been parsed into a plurality of separately deliverable segments. Each segment may represent a portion of the source media stream, for example, a five or ten seconds increment of the media stream. The media delivery service may include an HTTP server that responds to requests from a client, and furnishes the coded segments in response to those requests. The requests may identify requested segments by an address, such as a uniform resource locator (commonly, “URL”). A common server may respond to service requests from a number of different client devices. The request may also be a single request from a gateway or representative of a group of client devices, for example the request may be made by a router connecting several client devices in a local area network (“LAN”).

Media, such as video, can be delivered in various manners. One form of media delivery is streaming and downloading media content substantially simultaneously, which allows for immediate playback but has compromised video quality. For example, if download speeds do not meet playback demands, the playback may stall. Alternatively, the media stream can be entirely downloaded, then played, which provides high quality playback, but typically involves a delay in beginning playback of the video, because sufficient frames must be downloaded before the video can be played.

Furthermore, each requesting client is typically provided with its own copy of a coded segment, and thus, support of multiple requests for the same coded segment can consume unnecessary bandwidth within a network between the server and the client(s). These challenges are exacerbated by the rising popularity of high-definition streaming video.

### BRIEF DESCRIPTION OF THE DRAWINGS

FIG. 1 is a simplified block diagram of a video content delivery and client caching system according to an example embodiment.

FIG. 2 is a flowchart of an exemplary method for downloading and playing a media stream according to an example embodiment.

FIG. 3 is a flowchart of an exemplary method for selecting and providing portions of a media stream according to an example embodiment.

FIG. 4 is a diagram of an exemplary video segment distribution in a video content delivery and client caching system according to an example embodiment.

### DETAILED DESCRIPTION

Embodiments of the present invention provide techniques to distribute video content among a plurality of associated devices by identifying segments associated with the video content. For each identified segment, if it is determined that the segment is stored by one of the associated devices, other associated devices requesting the segment may retrieve the segment from the device storing the segment. Otherwise, the segment may be delivered directly to the device requesting the video content.

By perceiving a need in the art for a media delivery system that adapts to the bandwidth of recipient clients, the inventors have developed a method and system for predictively selecting, delivering, downloading, and caching content, which can be played in real time without (or with a minimal) initial delay in playback, while maintaining the quality of the content. The media delivery system balances a trade-off between the quantity and quality of content delivered, by selecting a quality level of content that best matches the bandwidth available for transmitting the content. The system may also efficiently utilized a given bandwidth to deliver content more likely to played by a client, so that bandwidth is not wasted on downloading videos that will not be played by the client or is not immediately needed by the client. For example, if download speeds are relatively low, the media delivery system can prudently select a more relevant or popular video clip or deliver a version of content that is of lower quality, so that a larger portion of a video clip may be downloaded in a given period of time compared with a higher quality version of the video clip. The media delivery system may also exploit connections between client devices to send a video segment to a client device, which the client device may then share with neighboring client devices.

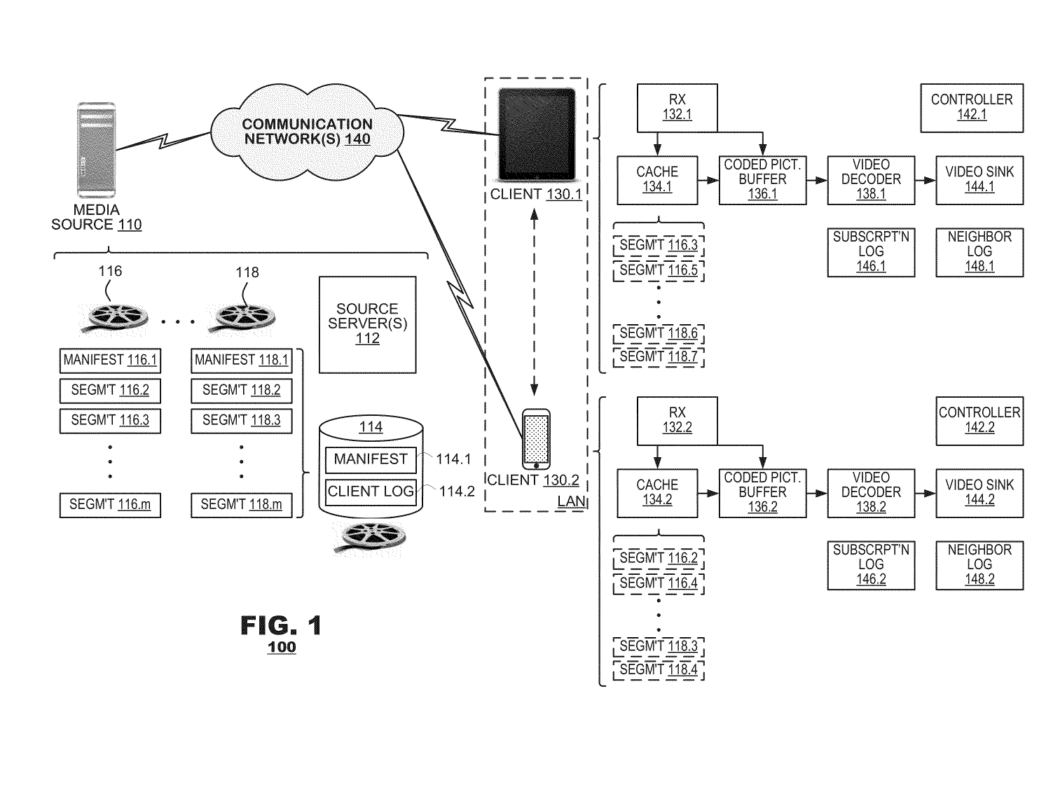

FIG. 1 is a simplified block diagram of a video content delivery and client caching system 100. The system 100 may include a media source 110 and a plurality of client devices 130.1, 130.2, provided in communication by a communication network 120. The media source 110 may store video content and deliver it to client devices 130.1, 130.2 on request. The clients 130.1, 130.2 may initiate requests for the video content in response to operator controls and, once they receive the video content, decode and play the received video content.

The media source 110 may include a server or network of servers (not shown) 112 and a database 114 that stores a manifest file 114.1, an optional client log 114.2 and coded video files 116, 118. The manifest file 114.1 may store data representing the video files that are available for retrieval. The video files 116, 118 may represent individual programs that are stored by the media source, for example, movies, television programs, music videos and the like. The coded video files 116, 118 may include a manifest file 116.1, 118.1 (which may be part of or separate from manifest file 114.1) and a plurality of addressable segments 116.2-116.m, 118.2-118.n. The manifest files 116.1, 118.1 may contain a list of the segments for the associated video file 116, 118 and network addresses (for example, uniform resource locators) where those segments may be requested. Each segment 116.2-116.m, 118.2-118.n may represent a corresponding portion of the media stream, for example a five minute increment of the media stream.

Although not illustrated in FIG. 1, a media source 110 may store several versions of individual programs, each coded according to different expectations of rendering. For example, a given movie may be coded at a first frame size for rendering on a small-sized display (e.g., a smartphone or handheld computer) and may be coded at a second frame size for rendering on a larger-sized display (e.g., a tablet computer, notebook computer or desktop computer). Indeed, the same movie may be coded for rendering on an extremely large-size display (e.g., a HDTV display). Additionally, individual programs may be coded at different frame rates, at different levels of coding quality and possibly at different coding complexities to account for variation in expected processing resources available at client devices when they decode and render the content and also to account for variation in bandwidth that can be provided by the communication network to carry the coded video between the media source 110 and the client devices 130.1, 130.2. In such applications, different coded variations of a program will be addressed differently from the others.

The source server(s) 112 may field requests from the clients 130.1, 130.2 and may furnish data in response to those requests. A client device, for example, may request data that describes the video programs stored by the media source 110; in response, the server 112 may furnish data from manifest file 114.1, which may describe topical information the video files 116, 118, for example, title, length. Alternatively, the client may request data regarding a single video file 116; in response, the server 112 may furnish data from manifest file 116.1, which provides additional data regarding the video file 116, for example, coding parameters and addresses of individual segments 116.2-116.m. A client may request an individual segment (say, segment 116.3), in which case the server 112 may furnish the requested segment 116.3. In doing so, operation of the media source 110 may be subject to other control processes that are not relevant to the present discussion, such as authentication of client devices, processing of payments for content, parental controls and the like.

The clients 130.1, 130.2 may receive, decode, and/or play media content. FIG. 1 illustrates basic elements that are common to clients, including for example, receiver 132.1, a cache 134.1, a coded picture buffer 136.1, a video decoder 138.1, a video sink 144.1, a subscription log 146.1, a neighbor log 148.1, and a controller 142.1. The components of an exemplary client 130.1 are described, and, although not detailed for the other clients, it should be understood that the other clients may also include components similar to those described for client 130.1. For example, each client may have its own set of: receiver, cache, coded picture buffer, video decoder, video sink, subscription log, neighbor log, and controller.

The receiver 132.1 may receive a coded video segment and may store it in the cache 134.1 and/or in the coded picture buffer 136.1. The cache 134.1 may store video segments which, when decoded, may form at least part of a playable video clip. The coded picture buffer 136.1 may also store video segments. In an embodiment, the coded picture buffer stores video samples immediately usable for decoding, while the cache 134.1 stores pre-fetched data before decoding or overflow segments.

The video decoder 138.1 may operate according to any of a number of different coding protocols, including, for example, MPEG-4, H.263, H.264, and/or H.265 (HEVC). Each protocol defines its own basis for defining pixel blocks and the principles of the present invention may be used cooperatively with these approaches. The video sink 144.1 may consume the coded video data, typically by rendering the data on a display or perhaps storing it for later use.

The subscription log 146.1 may include settings associated with the client 130.1, for example, a listing of video content to which a client (or a user of the client) has subscribed. The neighbor log 148.1 may store a list of neighbor clients (say, client device 130.2) that are associated with the client 130.1, including, for example, attributes such as cache sizes and downloading capabilities of the associated neighbor client. The controller 142.1 may control overall operation of the client 130.1.

According to an embodiment, clients 130.1, 130.2 may accelerate download and rendering of video files by exchanging segments among themselves prior to delivery from a media source 110. For example, when a client device 130.1 is engaged to begin rendering of a newly selected video file 116, the client device 130.1 may determine, with reference to its subscription log 146.1 and neighbor log 148.1, whether segments of the video file can be retrieved from another client 130.2 with which it is associated. The other client 130.2 may have prefetched a segment 116.2 of the video file and may be positioned to deliver the segment 116.2 to the client device 130.1 faster than could the media source 110.

In an embodiment, which clients share a cache may be determined by a shared user account or linked user accounts. For example, members living in the same household each having their own device may share a user account for a software application for downloading and streaming video. In a further embodiment, which clients share a cache may be defined by the neighbor log of each client. For example, if a client is in communication with a neighbor client and meets a threshold downloading suitability, the client may share a cache with the neighbor client. Two members of the household that watch the same television show may share a cache, so that the video is downloaded when the first member watches the television show, and is then readily available in the cache and easily retrievable by the second member over a LAN instead of from the media source when the second member desires to watches the television show later.

In another embodiment, the neighbor log 148.1 may be periodically updated to reflect changes in connectivity with neighbor devices. For example, devices may leave a LAN, and such a change may be reflected in the neighbor log. The subscription log 146.1 and the neighbor log 148.1 may each be in communication with the controller 142.1, and provide data for determining queries that the client sends to media sources to reflect the preferences of the client 130.1 and to optimize downloading of content as described further herein.

In a further embodiment, each client 130.1, 130.2 may have its own cache 134.1, 134.2. Caches may collaborate to store material and may communicate with each other to optimize downloading of material that may be shared among clients. In an alternative embodiment, one or more clients 130.1, 130.2 may access a single cache. Sharing cache, whether by using a single cache between multiple devices or accessing caches corresponding to different devices, reduces the consumption of bandwidth between clients and a server, because a single copy of a video segment may be downloaded to the cache, and the clients may then locally retrieve the content from neighboring devices.

For example, in operation, client 130.1, 130.2 may share a cache. Client 130.1 may have stored in its cache segments 116.3 and 116.5, but not segments 116.2 and 116.4. Client 130.2 may have stored in its cache segments 116.2 and 116.4, but not segments 116.3 and 116.5. Thus, the clients would benefit from sharing their respective cached segments to form a complete media stream. To play an entire media stream, client 130.1 may obtain segments 116.2 and 116.4 from client 130.2 so that it has all of the segments 116.2 to 116.4 for playback. In another example, client 130.1 may have stored in its cache the first half (segments 118.1 and 118.2) of a media stream 118, while client 130.2 may have stored in its cache the second half (segments 118.3 and 118.4) of a media stream 118. The clients may collaborate to form a complete media stream by sharing cache.

In FIG. 1, the client devices 130.1 and 130.2 are illustrated as tablet computers, and smart phones, but the principles of the present invention are not so limited. Embodiments of the present invention find application with laptop computers, desktop computers, personal media players, set-top video decoding devices, DVD players, or a client software application. The network 120 represents any number of networks that convey coded video data among media source 110 and clients 130.1, 130.2, including for example, wireline and/or wireless communication networks. The communication network 120 may exchange data in circuit-switched and/or packet-switched channels. Representative networks include telecommunications networks, local area networks, wide area networks and/or the Internet. For the purposes of the present discussion, the architecture and topology of the network 120 is immaterial to the operation of the present invention unless explained hereinbelow. The video content may be delivered over a network, such as a LAN, the Internet, or a telecommunications network. The clients may also access the source server through multiple independent networks. Some clients may communicate with the media source via Internet, while others may communicate with the media source via a cellular network. The clients 130.1, 130.2 may be coupled to form a local network and the clients 130.1, 130.2 may be communicatively coupled to each other, for example via a wireless network to form a LAN or paired via BLUETOOTH to form a personal area network (“PAN”), piconet, scatternet, etc. (the local network formed by clients is referred to as “LAN” herein for simplicity). In an embodiment, the video content may first be delivered to a LAN formed by a group of clients via the Internet, then the content may be further delivered to individual clients by the LAN. The clients may have multi-peer connectivity and send contents of their respective cache to other clients in the same LAN. Alternatively, communications between clients may be transmitted through the server.

The methods described herein may also find application in service infrastructures that uses multicast or hierarchical server caching. For example, a local server that provides content to a number of users may determine which movies to cache based on common interests of the users it serves.

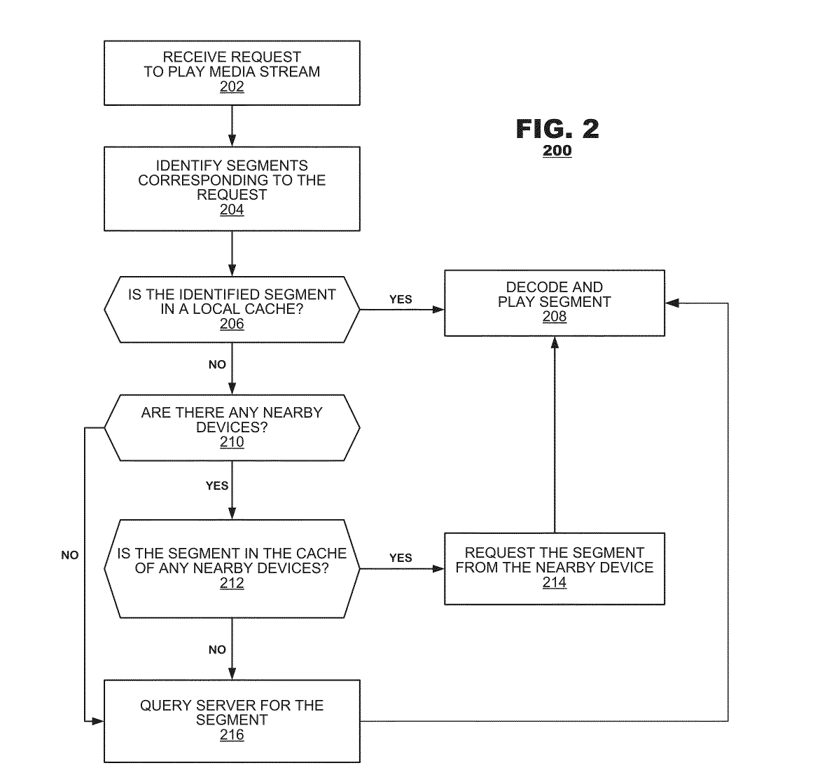

FIG. 2 illustrates a method 200 for downloading and playing a video file according to an embodiment of the present invention. The method 200 may begin when a first client receives a request to play a video from, for example, an operator or operating system (box 202). The method 200 may identify segments of the video file that must be decoded during playback (box 204). For each identified segment, the method 200 may determine whether the segment is available locally in a cache of the first client (box 206). If the segment is available in the cache, the client device may retrieve the segment from the local cache and begin decode and playback of the segment (box 208). For example, the device may examine cache 134.1 shown in FIG. 1 to determine whether a desired segment is in the cache.

If the segment is not in the cache, the method 200 may determine whether there are any other clients associated with the first client (box 210). If there are no nearby devices, the method 200 may query a media source 110 for the segment (box 216). If there is at least one nearby device, the method 200 may determine whether the requested segment is available for download from another client associated with the first client (box 212). If the requested segment is available for download from another client, the method 200 may request the segment from the other client (box 214). The method 200 may advance to box 208 and begin decode and playback of the downloaded segment. If the method 200 determines in step 212 that the segment is not available from another device, the method 200 may query a media source 110 for the segment (box 216), and upon receipt of the segment from the server, decode and play the segment (box 208).

The method 200 may repeat steps 204-216 to continue downloading additional video segments until an entire coded video file is downloaded. For example, an entire coded video file 116 may be made up of segments, for example, segments 116.2 to 116.5. In an example, each media stream may represent a complete movie and each segment may represent a portion of the media stream, for example a thirty-second increment of the media stream. Client 130.1 may have stored in its cache segments 116.2 and 116.4, but not segments 116.3 and 116.5. Client 130.2 may have stored in its cache segments 116.3 and 116.5, but not segments 116.2 and 116.4. Clients 130.1 and 130.2 may be determined to be neighboring devices with a connection that is suitable for sharing cache in step 208 according to the techniques further described herein. Thus, while the video is being played back by client 130.1, steps 204-214 may be performed to continue downloading segments 116.3 and 116.5 from client 130.2 without delaying (or with minimal delays to) playback. The client may also pre-fetch segments before they are needed for decoding to stay ahead of playback. Examples of the order in which the client may pre-fetch the segments is further discussed herein with respect to prioritization of segment download.

According to method 200, although client 130.1 does not have segments 116.2 and 116.4, client 130.1 may obtain segments 116.2 and 116.4 from nearby client 130.2 so that at least a contiguous portion of the segments making up video 116 can be assembled, decoded, and played. In another example, client 130.1 may have stored in its cache the first half (segments 118.1 and 118.2) of a coded video file 118, while client 130.2 may have stored in its cache the second half (segments 118.3 and 118.4) of the coded video file 118. Client 130.1 may retrieve segments 118.3 and 118.4 from nearby device 130.2 to form at least a portion of a media stream needed to begin playback. Similarly, while the video is being played back by client 130.1, steps 204-216 may be performed to continue downloading segments 118.3 and 118.4 from client 130.2 without delaying (or with minimal delays to) playback.

The determination of whether a video segment is available for download from another client can be done in a variety of ways. In a first embodiment, the method 200 may consult a neighbor log 148.1 to determine whether there are any active nearby neighbors. If there are active neighbors, the method 200 may then request data from the neighbors. If there are no active neighbors, the method 200 may download a new neighbor log or updates to a neighbor log responsive to a query to the server (box 216).

The neighbor log 148.1 may store a list of neighbor clients (also “nearby clients”) in communication with the client 130.1, including, for example, attributes such as accessibility, range, and downloading capabilities of the associated neighbor client. The neighbor log 148.1 may be periodically updated to reflect changes in connectivity with neighbor devices. For example, devices may leave a LAN, and such a change may be reflected in the neighbor log.

In a further embodiment, the video segment may be downloaded based on evaluations of the suitability of nearby devices for providing the segment. In such an embodiment, a requested segment may be downloaded if it is both available in the cache of a nearby device, and the nearby device is accessible, within range, and capable. For example, the method 200 may determine whether a nearby device is accessible, within range, and capable. The accessibility of a nearby device may be determined based on recent communications between the nearby device and the client device 130.1. For example, the client device 130.1 may periodically ping a nearby device and log the time of a response of the nearby device indicating that the nearby device was still active. A nearby device may be considered accessible if it was in communication with the client device 130.1 within a pre-definable time period before the present time. The accessibility of the nearby device may also be based on whether a nearby device is communicatively coupled to the client device 130.1. For example, in a BLUETOOTH network, the client device 130.1 may ping a nearby device to determine whether the two devices are paired.

The range of a nearby device 130.2 may be a quantification of a download and/or upload speed between the device 130.1 and the nearby device 130.2. For example, a range can be an amount by which the download and/or upload speed exceeds a threshold value. A bandwidth between the clients may be considered sufficient if an estimated time to download a segment is below a threshold.

The capability of the nearby device 130.2 may be a measure of the connection between the nearby device 130.2 and the media source 110. For example, it may measure download and upload speeds between the nearby device 130.2 and the media source 110. Because devices may be communicatively coupled to the media source over different types of connections and each may use different communications standards and have different hardware configurations, the capabilities of one device may be different from the capabilities of another device, even if they are both in the same LAN. The nearby devices may be ranked according to their accessibilities, capabilities, and ranges relative to the device.

In an embodiment, if multiple devices associated with a client are suitable candidates from which the requesting device can download a segment, the requesting device may download the segment over the best connection. For example, a ranking of the nearby devices in the neighbor log may be used to determine the best connection. The selection may alternatively be based on the nearby device that is, on average, the most accessible, within range, and capable. The selection may alternatively be based on a weighting of each of the factors.

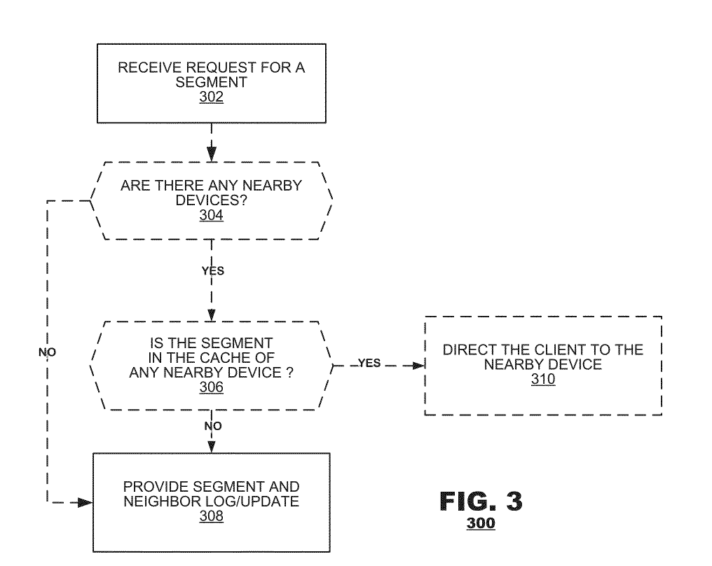

It is also possible that a segment is available in nearby devices, but it would be more efficient to obtain a segment directly from a server instead of obtaining the segment from a nearby device. For instance, the bandwidth between the devices 130.1 and 130.2 may be poorer than the bandwidth between a device 130.1 and the media source 110. For example, two nearby devices may be coupled via a weak BLUETOOTH connection, which may not be as fast as an Internet connection by which each device is connected to the server. In this situation, the segment may be requested directly from the server. A method by which a server may select and push a segment to the client device for downloading is described in further detail in relation to FIG. 3.

FIG. 3 illustrates a method 300 for selecting and sending portions of a media stream according to an embodiment of the present invention. For example, a media source 110 shown in FIG. 1 may perform method 300 to select and provide video segments to one or more clients 130.1, 130.2 for decoding and playback.

In a first step 302, the method 300 may receive a query for video data. For example, the request may be received from a client device. In an embodiment, the request may be for a specific video segment, and the source may find the requested segment in its coded video files 114. In an alternative embodiment, the request may be for a media stream or a portion of a media stream, and the server may determine the appropriate segment to provide to the requesting client. For instance, a media stream may be formed by several segments, and the source may determine the next segment that is needed by the media stream. The source may also queue a several segments to push to the client, for example, according to the prioritization techniques described further herein.

When the appropriate segment is identified by the server, the method may proceed to push the segment to the client, either directly or through a nearby device. In an embodiment, the method 300 may push the requested segment to the requesting client, along with a neighbor or an update to a neighbor log (box 310). The contents of the neighbor log are further discussed herein, and may be used by the client for obtaining other segments from its nearby devices, for example, according to method 200.

In an alternative embodiment, method 300 may determine whether there are any devices associated with the requesting device (box 304), and if so, whether any nearby devices already have the requested segment (box 306). If any nearby devices already have the segment, then the method 300 client may direct the requesting client to retrieve the data from its neighbor (box 310). Otherwise, if the segment is not in the cache of any associated devices, the method 308 may proceed to provide the segment and a neighbor log (or update of the neighbor log) to the requesting client (box 308).

A group of client devices may be considered “nearby,” if the devices are communicatively coupled to each other, for example all in the same LAN or together form a BLUETOOTH piconet or scatternet. The method 300 may provide updates to the neighbor log regarding the nearby devices, e.g., nearby devices that have left or joined the LAN and their respective attributes. A list of the nearby devices may be maintained in the client log 114.2 of the source 110. The method 300 may also periodically determine whether client devices have joined or left a local network of client devices and log this information in the client log 114.2. The characteristics of each client, e.g., such as accessibility, range, and downloading capabilities, may be provided to the server 110 over a network, such as the one illustrated in FIG. 1. The client device may report information regarding its hardware and software specifications and available cache to the source server. The server may analyze specifications provided by the client device to determine the client device's suitability for receiving downloads. The characteristics of a client may also be conveyed through a user account (as further discussed herein in relation to FIG. 1) so that when a client does not report its specification, the server may make its determinations based on the user account information. For instance, the server may be connected to a LAN via the Internet, while the device is a cellular device operating on a telecommunications network and not accessible by the server.

Information about the proximity of client devices to each other and their performance specifications may be used by the method 300 to determine an order in which to provide video segments and which segments are provided to which clients. This download optimization allows a bit stream to be built in a scalable way such that, even given bandwidth constraints, a client device can smoothly stream a video. Given a bandwidth of a group of client devices, e.g., a LAN, a resolution of the video segments may be selected to enhance the viewing pleasure of the user.

The source server may split the requested content into several video segments and send various segments to different nearby clients to decrease the amount of time it takes to download the requested content. For instance, for a coded video file 116, the method 300 may send segments 116.2 and 116.4 to client 130.1 and segments 116.3 and 116.5 to client 130.2. The requesting client may then be directed to each of its nearby clients to piece together the requested content as described further herein.

In yet another embodiment, method 300 may be performed to provide content to client(s) absent a request from the client(s). For example, the server may queue up and push video segments to clients, and the video segments may be cached locally over time as they become available from the source server. For example, content may be pushed to clients for download while the client is inactive or when playback is paused. Alternatively, content may be pushed to clients while another video segment is playing.

The queuing up of video segments for download may be predictively performed based on popularity among all or a sub-set of users of a software application, a viewing history of a user of the client device, interests of the user of the client device, and/or a user's active choices, for example, as indicated by selections in a subscription log. For example, while a user is navigating a UI, user behavior may trigger caching. Content associated with a synopsis or trailer may be cached, e.g., while a user is watching a trailer or while a synopsis is displayed on the UI (the user is presumably reading the synopsis) or watching the trailer. In an alternative example, the predictive downloading is performed based on a combination of a user's interests and subscriptions. Information regarding a user's preference may be associated with a user account such that the preferences for a particular user may be associated with more than one client device. Users associated with one another, e.g., in physical proximity to each other, may be inferred to have similar interests. The user account may include information regarding all of the client devices that are used by the user.

Because a local cache size may be limited or available bandwidth to the cache may be limited, the order and/or duration of content loaded to the cache may be prioritized. Content may also be at least partly randomly cached. Additionally, the basis and/or manner for the prioritization for caching may be one or more of the following:

Partial download (e.g., one or a few video segments) of each item on a user's subscription list;

The beginning (e.g., the first minute) of each item on a user's subscription list may be cached, which may provide a quick start-up when viewing the items on the list;

A lower resolution version of each item in a user's subscription list may be downloaded before downloading a higher resolution version;

Higher resolution layers of a video sample may be downloaded at a lower priority than a lower resolution version: for example, download of higher resolution layers may begin once sufficient bandwidth and/or cache is available or may begin after a lower resolution version is partially or completely downloaded. For instance, when the method 300 determines that there is sufficient bandwidth during playback, enhancement layer representations can be downloaded and decoded on top of the cached base representation. The enhancement layers may relate to spatial, temporal (e.g., frame rate), and dynamic range aspects of the video sample;

The segments of video with higher bits that consume more bandwidth may be prioritized for caching to avoid pausing videos during playback in more bandwidth intensive segments. For example, a video decoder of the client (such as the decoder 138.1, 138.2 shown in FIG. 1) may be a scalable decoder, which allows for caching of lower bitrate base representations of a video sample;

A usage pattern of the user, which may be learned over time: for example, videos that are in a similar genre to videos previously viewed by a user may have a higher priority for download;

Splash screens that may appear at the beginning, end, or elsewhere in a video: for example, a production logo, an opening logo, a closing logo, and/or copyright warnings;

A summary of a movie or a video: for example, a movie may be divided into chapters and one or a few frames from each chapter may be cached, and, when played, provide a summary of the entire movie. In an example, the summary may be made up of video snippets, the video snippets being frames shown during fast-forwarding through a video selection. In an alternative example, the summary may be made up of key frames or I-frames. The chapters may be provided by a movie distributor. For example, this information may be provided by the media source as metadata to a client. A viewer may view the summary or view an entire movie by viewing the cached summary while fetching the missing parts; and

A selection of advertisements, which may be shared among the clients of the LAN. Thus, a delay in starting playback may be eliminated by playing the commercials, and while the advertisements are playing, additional video segments may be downloaded.

The cache may be periodically cleared, for example by evicting segments for least recently watched and least frequently watched video clips. The replacement policies may provide for some of the prioritized cached content to remain in the cache while other content is evicted. In an example embodiment, while video playback is paused, the cache may be updated to clear out content that has already been played and content subsequent to the resume point may be downloaded.

Information regarding what material is available for immediate viewing may be provided on a UI of a client device. For example, the UI may display and categorize content that is available for immediate viewing at full resolution, various intermediate resolutions, and low resolution streaming quality. The determination of what content is available for immediate viewing may be based on what is available in the cache of the client devices in a LAN. Caching may be performed in an interactive and/or supervised way. For example, a user may filter and indicate which ones of the displayed system recommendations to carry out. As a further example, notifications may be sent to users and user feedback may be used to carry out the caching. Users may specify types of predictive caching, for example full, partial, summarization, and quality level. Users may also specify starting times of video content viewing, and the system may adaptively select video tiers based on a bandwidth between caches, a bandwidth for communications between the source server and the clients.

Caching may also be adapted to the attributes of the content being cached. For example, if the content is live, the caching may be performed without ads. In another example, content providers may indicate the types of video segments being provided (e.g., via metadata), and a client may adapt caching based on the information provided. In a further example, events of interest may be automatically detected on the client side, and caching may be performed based on these automatically detected events of interest.

A source server or client may provide suggestions on a UI based on the contents of cache. For example, the server or client may suggest movies that have been at least partially cached in a LAN. For example, an episode of a television series not yet viewed, but at least partially cached by the user may be recommended. The recommendation may be provided on the UI of the client device.

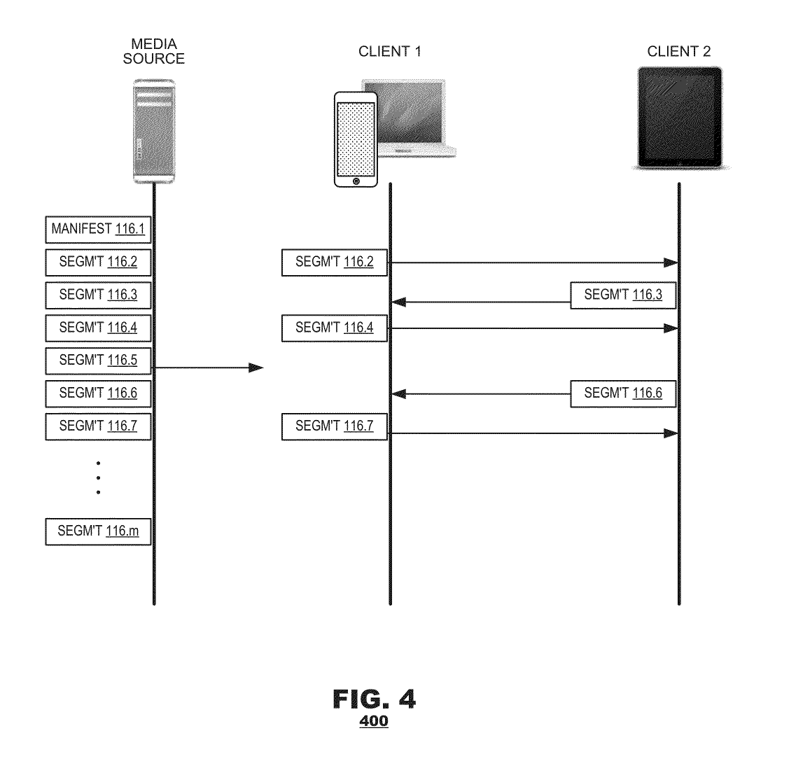

FIG. 4 illustrates a distribution 400 of video segments among neighboring clients 1 and 2 and a media source according to an embodiment of the present invention. The media source includes all segments 116.2-116.m making up a complete coded video file as well as a manifest file 116.1 that represents the video segments available for retrieval. In an initial configuration, client 1 has segments 116.2, 116.4, and 116.7 and client 2 has segments 116.3 and 116.6. These segments may be stored in a cache of the respective client devices, and may have been previously downloaded from the media source. In a sample scenario, client 1 may wish to play a video file 116, and may need at least segments 116.2 to 116.5 to begin playback. However, client 1 does not currently have segments 116.3 to 116.5. According to method 200, after discovering that segment 116.3 is not in its local cache (box 206), client 1 may discover that client 2 is a nearby device (box 210) and has the needed segment 116.3 (box 212). Client 1 may then request the segment from client 2. With respect to segment 116.5, client 1 may discover that client 2 also does not have the segment. Thus, client 1 may request the segment from the server (box 216). Once client 1 has segments 116.3 to 116.5, it may be begin playback without a delay. During playback, client 1 may continue to request segments needed for the rest of playback. For example, segment 116.6 may be requested from client 2.

The foregoing discussion has described operation of the embodiments of the present invention in the context of client devices that functional units (FIG. 1). Commonly, these components are provided as electronic devices. Video decoders and/or controllers can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic-and/or optically-based storage devices, where they are read to a processor under control of an operating system and executed. Decoders commonly are packaged in consumer electronics devices, such as smartphones, tablet computers, gaming systems, DVD players, portable media players and the like; and they also can be packaged in consumer software applications such as video games, browser-based media players and the like. And, of course, these components may be provided as hybrid systems that distribute functionality across dedicated hardware components and programmed general-purpose processors, as desired.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. Unless described otherwise herein, any of the methods may be practiced in any combination. For example, the methods of prioritizing video segments for download and pushing segments to various client devices may be practiced in any combination.

We claim:

1. A video player, comprising:
a communication transceiver;
a subscription log that stores identifiers of video content likely to be played by the video player and a media server from which the video content is available;
a neighbor log that stores an index of segments of video content stored by other player devices; and
a processor that, responsive to a request to play selected video content,
searches the neighbor log for identification of another player device that stores a segment associated with the selected video content,
when a match is found, causes the transceiver to transmit a request to the matching player device for video segments identified on the neighbor log, and
for segments for which no match is found, causes the transceiver to transmit a request to the media server for such segments.

2. The video player of claim 1, wherein the neighbor log further stores, for each other player device, data indicating a time when the other player device last was in communication with the video player.

3. The video player of claim 1, wherein the subscription log is provided to the video player from the media server.

4. The video player of claim 1, wherein the subscription log is assembled from transmissions received by the video player from the other player devices.

5. The video player of claim 1, wherein:
a cache of each of the player devices in the neighbor log is accessible by the video player;
prior to transmitting the request for video segments, the processor determines whether video segments are in the cache of any of the player devices in the neighbor log; and
the transmission of the requests for video segments is performed responsive to a determination that the requested video segments are not in the cache of any of the player devices in the neighbor log.

6. A method for retrieving requested video content at a first device, comprising:
responsive to a request to play selected content, identifying segments of content to be played;
for each identified segment:
determining whether the respective segment is stored by a neighboring client device;
if the respective segment is determined to be stored by the neighboring device, requesting the segment from the neighboring device; and
otherwise requesting the segment from a media server to which the first device is communicatively coupled.

7. The method of claim 6, wherein
the identifying comprises searching a subscription log stored by the first device that identifies a set of segments associated with the selected content, and
the determining and requesting steps are performed for the segments on the subscription log identified by the search.

8. The method of claim 6, wherein the identifying comprises searching a manifest file downloaded from the media server to the first device that identify neighboring client device(s) that store segments of the selected content.

9. The method of claim 6, wherein the determination comprises searching a neighbor log stored by the first device that identifies neighboring client device(s) associated with the first device and a time that each such neighboring client device was most recently confirmed to be in communication with the first device.

10. The method of claim 6, wherein the segment is requested from the neighboring device responsive to a determination that a most recent communication with the neighboring device is within a threshold time period.

11. The method of claim 6, wherein the segment is requested from the neighboring device responsive to a determination that at least one of a download speed and an upload speed, between the video player and the neighboring device, is above a threshold value.

12. The method of claim 6, wherein the segment is requested from the neighboring device responsive to a determination that the neighboring device downloads content from the media server above a threshold speed.

13. The method of claim 6, further comprising receiving the requested segment from the server.

14. The method of claim 6, wherein the determination comprises searching a neighbor log stored by the first device that identifies neighboring client device(s) associated with the first device and segments of content stored by each neighboring client device.

15. The method of claim 14, further comprising building the neighbor log from transmissions received from the neighboring client device(s) that identify segments of content respectively stored by those neighboring client device(s).

16. The method of claim 14, further comprising building the neighbor log from a transmission received from the media server that identify segments of content respectively stored by those neighboring client device(s).

17. The method of claim 14, wherein responsive to a determination that more than one neighboring device contains the requested segment, downloading the requested segment from the neighboring device that, on average, communicated most recently with the first device, has the highest download and upload speed, and has the highest download speed with respect to the media server.

18. The method of claim 14, wherein the neighbor log is initially provided by the server and subsequently updated in the respective video player.

19. A method of prioritizing video segments for downloading and playing on a video player, the method comprising:
receiving specifications of a video player to which at least one video segment is provided, wherein the specifications include a subscription log including preferences and a neighbor log including nearby devices communicatively coupled to the video player;
determining an order in which to push the video segments to the video player; and
delivering the video segments to the video player according to the order.

20. The method of claim 19, further comprising:
prior to determining an order in which to push the video segments to the video player, receiving a request to play a media stream;
wherein the order in which to push the video segments is based on at least one video segment corresponding to the request to play the media stream.

21. The method of claim 19, wherein the prioritization is based on partially downloading each item in the subscription log.

22. The method of claim 19, wherein the prioritization is based on downloading a beginning portion of at least some items in the subscription log.

23. The method of claim 19, wherein the prioritization is based on downloading a lower bitrate version of at least some items in the subscription log before downloading a higher bitrate version of the at least some items in the subscription log.

24. The method of claim 19, wherein, for variable bitrate coding, the prioritization is based on downloading segments with a higher bitrate before downloading segments with a lower bitrate.

25. The method of claim 19, wherein the prioritization is based on a usage pattern of the video player.

26. The method of claim 19, wherein the prioritization is based on downloading splash screens that are common to several segments.

27. The method of claim 19, wherein the prioritization is based on:
dividing a video into several chapters; and
caching a predefined number of frames from each chapter.

28. The method of claim 19, wherein the prioritization is based on downloading advertisements before downloading other content.

29. The method of claim 19, wherein segments are pushed to more than one video player based on a respective suitability of each video player and the segments are accessible between the video players.

30. The method of claim 19, wherein the prioritization is based on downloading lower bitrate layers of the at least one video segment before downloading higher bitrate layers of the at least one video segment.

31. The method of claim 30, wherein the download of the higher bitrate layers begins responsive to a determination that at least one of: a bandwidth and a cache of the video player is above respective threshold values.

32. The method of claim 30, wherein the download of the higher bitrate layers begins responsive to a determination that the lower bitrate layers are completely downloaded.

33. A method of providing a video segment to a video player, the method comprising:
receiving a request for the video segment; and
providing the requested segment and a neighbor log of nearby devices, wherein a nearby device is communicatively coupled to the video player.

34. The method of claim 33, further comprising, prior to providing the requested segment:
determining whether the requested segment is in a cache of any of the nearby devices to the video player; and
responsive to a determination that the segment is in the cache of at least one nearby device, directing the video player to the at least one nearby device for the requested segment.

35. The method of claim 33, further comprising responsive to a determination that more than one nearby device is suitable for receiving the segment, providing the segment to the nearby device that is, on average, most accessible, capable, and within range to the first device.

36. A storage device storing program instructions that, when executed by a processing device, causes the processing device to:
receive a request to play the segment;
determine whether the requested segment is in a cache of the video player;
responsive to a determination that the requested segment is not in the cache of the video player, determining whether the requested segment is in a cache of at least one nearby device communicatively coupled to the video player;
responsive to a determination that the requested segment is in the cache of the at least one nearby device, download the requested segment from the at least one nearby device, decoding and playing the requested segment; and
responsive to a determination that the requested segment is not in the cache of any of the at least one nearby device, request the segment from a server to which the video player is communicatively coupled.

37. A storage device storing program instructions that, when executed by a processing device, causes the processing device to:
receive specifications of a video player to which at least one video segment is provided, wherein the specifications include a subscription log including preferences and a neighbor log including nearby devices communicatively coupled to the video player;
determine an order in which to push the video segments to the video player; and
deliver the video segments to the video player according to the order.
